(19) United States
(12) Patent Application Publication
(10) Pub. No.: US 2008/0127542 A1
(43) Pub. Date: Jun. 5, 2008

(54) FISHING LURE

(76) Inventor: Edward Ray Young, Gatesville, TX (US)

Correspondence Address: NAMAN, HOWELL, SMITH & LEE, P.O. BOX 1470, WACO, TX, 76703, US

(21) Appl. No.: 11/566,547

(22) Filed: Dec. 4, 2006

(51) Int. Cl. A01K 85/00

(52) U.S. Cl. 43/42.36; 43/42.39; 43/42.24

(57) ABSTRACT

The present invention is generally directed toward an artificial fishing lure component. In particular the present invention is directed toward a fishing lure component simulating a worm's head, which may be used as a slip sinker, a pegged sinker, or simply as an addition to a traditional, artificial worm lure to facilitate the natural movement of live bate in weeds, brush, twigs, and stone. The present invention is conically shaped and composed of soft flexible material with a cavity for snugly encapsulating a weighted sinker. The present invention may be used in a variety of configurations including both Texas and Carolina Rigs.

### BACKGROUND OF THE INVENTION

1. Field of the Invention

The present invention is generally directed toward an artificial fishing lure component. In particular the present invention is directed toward a fishing lure component simulating a worm's head, which may be used as a slip sinker, a pegged sinker, or simply as an addition to a traditional, artificial worm lure to facilitate the natural movement of live bate in weeds, brush, twigs, and stone.

2. Background Information

Fishing, in particular bass fishing, is often associated with the use of soft plastic baits. Most often, the traditional soft plastic bait is in the shape of a worm. The typical soft, plastic artificial worm is made from a liquid plastic material such as plastisol, alone or in combination with softeners or hardeners depending on the application. However, regardless of the exact material formula used, the final product must be as close to the look, feel, and consistency of a live worm as possible for optimum effectiveness in attracting and catching premium fish.

One of the most recognized methods of fishing plastic worms is with the Texas Rig. The Texas Rig consists of a plastic worm, a worm hook, and a sinker. In this rig style, the fishing line, or monofilament, is first threaded through a sinker, such as a lead (or other type of metal) “bullet” or “egg” style weight. Next, the monofilament is secured to the worm hook, and the hook is inserted through the upper section of the bait leaving a portion of the shank inside the artificial worm and reinserting the point and barb into the upper mid-section of the artificial worm. This results in a rig with an offset worm hook in a “weedless” configuration. This configuration is considered “weedless” because all sharp edges of the hook are embedded into the artificial worm, such that the rig will more easily move through vegetation. The primary reason for the added weight is to force the bait to the bottom of the water column as well as providing for easier and longer casts.

When fishing a Texas Rig, the angler casts the rig to a particular spot within a body of water, wherein the rig descends to the bottom. Once the rig fully descends, the angler slowly reels the bait in, such that the bait moves along the water bed, simulating the movement of a real worm.

The sinker for a Texas Rig may be of a slip sinker or pegged sinker type. The slip sinker configuration allows the sinker to slide along the line; the pegged sinker type fixes the weight against the “head” end of the plastic worm. In application, a slip sinker is used to let the fish take the bait without feeling the unnatural sensation of a lead weight. However, some anglers prefer the pegged type because they do not wish to have the artificial movement of a lead weight sliding along the line.

Another popular type of fishing rig is the Carolina Rig. The Carolina Rig also consists of an offset worm hook and a slip or pegged sinker, but in the Carolina Rig configuration, the sinker is separated from the bait by a particular length of monofilament. In application, the use of the Carolina Rig is virtually the same; that is, the angler casts the rig into a body of water, wherein the rig descends to the bottom of the water column. Once the rig fully descends, just as with the Texas Rig, the angler slowly reels the bait in, such that the bait moves along the water bed, attempting to simulate the movement of a real worm.

Either configuration, as is well known in the art, has its own problems and drawbacks associated therewith. First and foremost are the artificial look, feel, sound, and action of an artificial lead weight sinker (or any other hard material). As previously mentioned, sinker weights are typically either bullet or egg shaped. It has been discovered and is well understood that sinkers often skip along the water bottom or snag in vegetation or brush as they are reeled in. In an effort to allow the sinker and lure to freely pass through the aquatic vegetation, the bullet shaped sinker was developed and is often selected. However, as any seasoned angler knows, the nose of the bullet is still capable of becoming engaged with brush or twigs, causing the angler to increase the force with which the line is reeled. As the brush gives way and the lure is freed, the lure is forced to accelerate in an unnatural, jerky fashion. As a result of this unnatural action, the fish senses an erratically moving, foreign substance rather than a naturally moving worm and is deterred from striking.

In addition to the problems with the artificial movement of the prior art sinker components, the look and feel of the sinkers themselves provide a significant drawback in the prior art. Significantly, prior art sinkers do not simulate the true action of the head of a moving worm, particularly in a pegged Texas Rig. As most anglers that are familiar with live bait know, when a worm is moving through vegetation or through the water, the head end of the worm extends to a conical, almost pointed shape as it arches around in a searching type motion. Furthermore, particularly with the pegged Texas Rig, the artificial feel of a lead weight (or any hardened material) alerts a fish that has just drawn the bait into its mouth that the rig is not a natural worm. This causes the fish to instantly eject the bait, reducing the time for the angler to set the hook, often resulting in a lost opportunity.

Finally, the noise associated with the prior art sinker provides a problem as well. In particular, when a lead sinker (or a sinker made of or coated by another hardened material) is dragged through twigs, brush or stones, the sound emanating from the action is clearly noisy and artificial. The result is an artificial sounding noise unlike any naturally made from a live worm, leaving the fish again deterred from biting.

In view of the limitations associated with the prior art, a substantial need exists for an artificial fishing lure component that looks, feels, sounds and enables movement like that of natural, live bait. Applicant's invention, through a novel configuration of material, provides such a component.

### SUMMARY OF THE INVENTION

The general purpose of the present invention, which will be described subsequently in greater detail, is to provide an artificial lure, which contains many advantages of the prior art along with significant novel features that result in an artificial lure that is not anticipated, rendered obvious, suggested, or even implied by any known devices, either alone or in combination.

In view of the foregoing, it is an object of the present invention to provide an artificial fishing lure that looks like live bait.

It is another object of the present invention to provide an artificial fishing lure that feels like live bait.

It is another object of the present invention to provide an artificial fishing lure that enables movement to closely simulate that of live bait. It is another object of the present invention to provide an artificial fishing lure that mimics the sounds associated with the movement of live bait.

It is another object of the present invention to provide an artificial fishing lure that reduces the likelihood of becoming snagged in brush or twigs.

It is another object of the present invention to provide an artificial fishing lure that is versatile.

It is another object of the present invention to provide an artificial fishing lure that relieves stress concentrations in the fishing line at the lure interface.

In satisfaction of these and other related objectives, the present invention provides a device for realistic simulation of live bait. The present invention provides an artificial lure component, which may act as a sinker cover or merely as an addition to an artificial worm. The present invention is so configured to allow smooth, quiet movement in twigs, brush, rocks, and other water bed vegetation, while simulating the look and feel of a naturally moving worm.

In the preferred embodiment, the present invention is comprised of a unitary, conically shaped component with an elongated nose end. The component of the present invention is comprised of a soft, plastic material, such as that currently used for making artificial worm bait. In addition, the conically shaped component contains an aperture running from the elongated nose end to the broad end of the component. Finally, the component contains a cavity in the broad end of the conical shape as well.

In practice, the present invention may be used with or without a sinker weight, and it is capable of providing a fixed or a slip sinker configuration. In order to configure the present invention into a Texas Rig configuration, the fishing line or monofilament is first inserted through the aperture running throughout the conically shaped component starting at the elongated nose end and extending through the broad end. If configuring for use as a weighted sinker, a sinker weight, as known in the art, is then configured onto the monofilament and inserted into the cavity of the broad end of the present invention such that the flexible component of the present invention completely and snugly covers the weighted sinker. The monofilament is then, of course, engaged with the offset worm hook as known in the art. For a slip sinker configuration, the aperture of the component of the present invention is sized to fit loosely on the appropriately sized monofilament allowing the present invention (with the sinker weight snugly embedded) to slide freely on the monofilament. For a pegged sinker configuration, the aperture of the component of the present invention is merely sized to fit tightly on the appropriately sized monofilament, fixing the present invention (with the sinker weight snugly embedded) at the appropriate location on the monofilament. Furthermore, as one skilled in the art can plainly see, the component of the present invention can easily be configured into a Carolina Rig by appropriately modifying the preceding steps such that the present invention is located a specified distance from the hook and body of the artificial worm itself.

In practice, the use of the present invention yields significant advantages over the prior art. The most obvious, and probably most important, improvement associated with the use of the present invention is its capability of enabling smooth, silent movement through brush, twigs, or stone, closely simulating that of a real worm. For instance, as the rig is reeled in through brush and twigs, the flexible, elongated nose of the present invention not only avoids engagement with the obstacles, but it also allows the “head” of the worm to bend and flex as it works its way through the brush, just as a real worm does. Additionally, the present invention allows the movement through twigs or other obstacles to be slow and fluid rather than fast and jerky as associated with the prior art. This, in turn, projects an image to the fish as movement of a live worm, resulting in greater odds of a bite.

Additionally, the composition of the present invention offers significant advantages to that of the prior art. As previously stated, the present invention is composed of a soft, flexible material similar to that currently used in artificial worms. This soft “feel” is particularly advantageous when fishing a pegged Texas Rig configuration because as the fish draws the lure into its mouth, the entire structure of the rig feels like a real worm, masking the feel of an artificial weight member, again resulting in a greater tendency to keep the lure in its mouth longer, giving the angler more valuable time to set the hook. Furthermore, regardless of the configuration, the soft, flexible composition of the present invention results in quieter movement along hard structures, such as rocks, branches and twigs. This again results in a more realistic simulation of a worm's movement, resulting in greater odds of inducing a strike.

Finally, the configuration and composition of the present invention result in less stress on the monofilament itself, resulting in a longer lasting rig than that associated with the prior art. As previously referenced, the prior art rig configurations include monofilament threaded through the hard, sharp surfaces of a lead or metal weight. The repeated action of the monofilament in contact with this surface, especially when a fish is trying to “throw” the lure or wraps it around branches or other submerged structure that fish typically reside in for cover and protection, leads to significant wear and stress on the monofilament, often resulting in premature failure. By contrast, the present invention snugly surrounds the weighted member with a soft flexible plastic fashioned in an elongated conical shape. This configuration eases the wear and stress concentration associated with the prior art by lengthening the bend radius of the monofilament exiting the metallic weight. That is, the monofilament has significant contact spread throughout the flexible plastic member as opposed to all contact being focused in a singular spot, as in the prior art. Therefore, use of the present invention results in a longer lasting monofilament and a longer lasting rig.

In summary, then, an embodiment of the present invention provides an artificial fishing lure component that looks, feels, sounds and enables movement like that of natural, live bait.

### BRIEF DESCRIPTION OF THE DRAWINGS

Applicant's invention may be further understood from a description of the accompanying drawings, wherein unless otherwise specified, like referenced numerals are intended to depict like components in the various views.

FIG. 1 is a cross-sectional view of the apparatus of the present invention.

FIG. 2 is a perspective view of the present invention configured in a Texas Rig.

FIG. 3 is a cross-sectional view of the apparatus of the present invention in a “flexed” condition.

### DETAILED DESCRIPTION OF THE PREFERRED EMBODIMENT

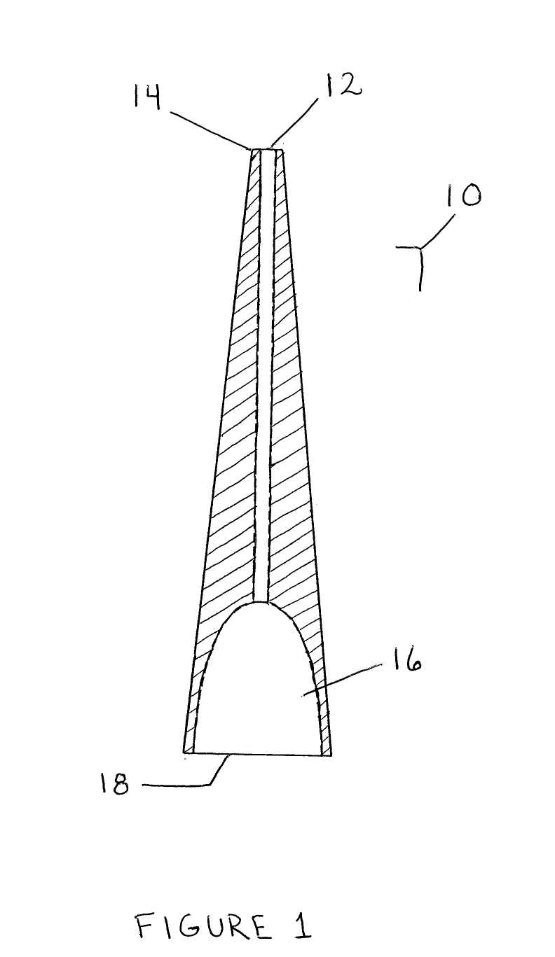

Referring to FIG. 1, an artificial fishing lure device is shown and is generally designated by numeral 10. In the preferred embodiment, the primary component of the device is composed of a soft, flexible plastic material similar to that presently used in the composition of artificial worm bait, such as plastisol alone or in combination with hardeners or softeners as known in the art. However, the device may be composed of other similar materials as known in the art, the primary objective being a resilient component that is extremely soft and flexible.

As seen in FIG. 1, device (10) is of general elongated, conical shape. Extending throughout elongate device (10) is aperture (12). Aperture (12), as previously stated, may be sized for either a snug or slip fit on various sizes of monofilament as is needed or desired for a particular application. However, regardless of the exact respective sizes of elongated device (10) and aperture (12), the material at the nose end (14) of device (10) should be extremely thin, such that very little material exists between a monofilament engaged with aperture (12) and the outer circumference of device (10) at nose end (14). Finally, cavity (16) extends partially into device (10) at broad end (18) of device (10). As previously mentioned, cavity (16) may be shaped and sized to snugly fit weight members of various sizes and shapes, whether conical, bullet, or egg shaped.

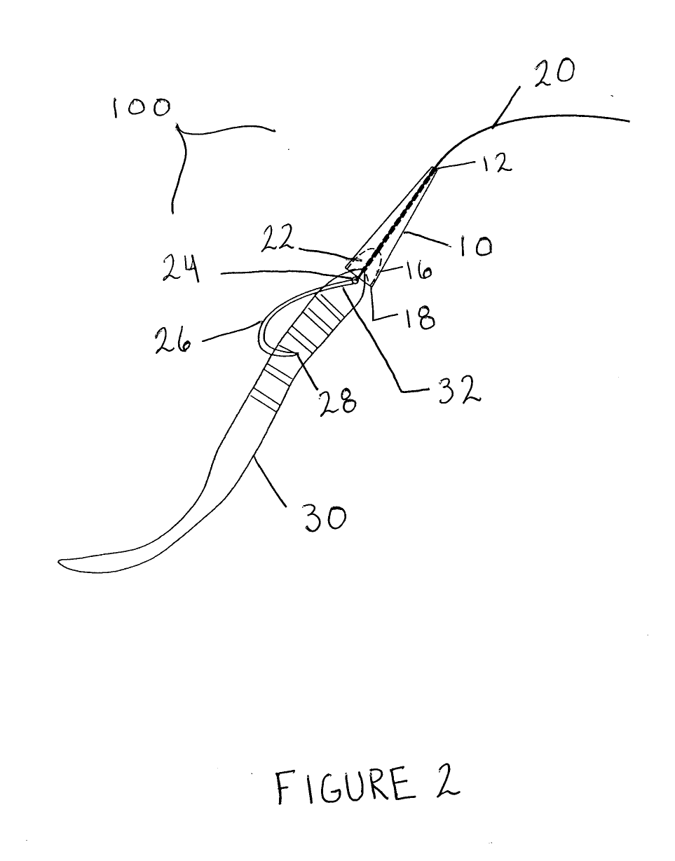

Now referring to FIG. 2, device (10) is shown configured into a Texas Rig apparatus (100). Apparatus (100) is first comprised of device (10) with monofilament (20) inserted completely through aperture (12). Monofilament (20) is then inserted through weight member (22) and tied to eye member (24) of worm hook (26). Moreover, as previously described, weight member (22) is inserted into cavity (16) at broad end (18) of device (10) for a snug, secure fit, with the material of device (10) substantially covering weight member (22). To complete Texas Rig apparatus (100), point (28) of worm hook (26) is pierced into artificial worm (30), resulting in both shank (32) and point (28) of worm hook (26) being embedded into worm (30).

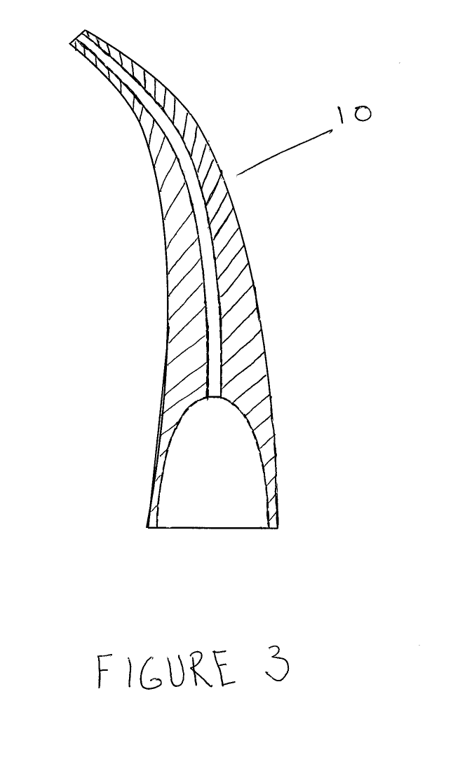

Finally referring to FIG. 3, device (10) is shown in a “flexed” condition. That is, since, as previously described, device (10) is composed of a soft, flexible material, such as the material presently used in making artificial worm lures, device (10) is able to flex significantly as it encounters and winds its way through brush and twigs. This ability to flex to such a significant degree allows device (10) to smoothly maneuver through vegetation and cover, simulating the action of a real worm to a degree not possible in any known prior art device.

In operation, a fishing lure including device (10) rigged such as Texas Rig (100), or some other configuration as known in the art, is used by the angler much like any other plastic worm fishing lure but with significant benefits. That is, rig (100) is cast into a body of water, preferably containing significant brush and vegetation for optimal fishing. After rig (100) is forced to the bottom of the water bed by weight member (22), the angler begins reeling in the line, putting tension in monofilament (20). As rig (10) is reeled in, device (10) bends and flexes through the vegetation and brush smoothly and silently, closely simulating the movement of a real worm. The culmination of the foregoing resulting in a realistic looking, feeling, and moving artificial bait, providing a more significant attraction to a fish than any known prior art device.

Although the invention has been described with reference to specific embodiments, this description is not meant to be construed in a limited sense. Various modifications of the disclosed embodiments, as well as alternative embodiments of the inventions will become apparent to persons skilled in the art upon reference to the description of the invention. It is, therefore, contemplated that the appended claims will cover such modifications that fall within the scope of the invention.

I claim:

1. A fishing lure component, comprising:
an elongate member having a proximal end and a distal end, said elongate member distal end being substantially broader than said proximal end, said elongate member having an outer surface wherein said elongate member outer surface conically tapers from said distal end to said proximal end, said elongate member having a slender aperture extending throughout from said proximal end to said distal end, said elongate member having a cavity in said distal end.

2. The component of claim 1 wherein said elongate member consists of a soft, flexible material.

3. The component of claim 2 wherein said soft, flexible material is substantially composed of plastisol.

4. The component of claim 2 wherein said cavity is formed to snugly cover a weighted fishing sinker.

5. The component of claim 4 wherein said cavity is conical, bullet, or egg shaped.

6. The component of claim 5 wherein said aperture member is sized for slideable engagement with a fishing line.

7. The component of claim 5 wherein said aperture member is sized for frictional engagement with a fishing line.

8. A fishing lure component, comprising:
an elongate member having a proximal end and a distal end, said elongate member distal end being substantially broader than said proximal end, said elongate member having an outer surface wherein said elongate member outer surface conically tapers from said distal end to said proximal end, said elongate member having a slender aperture extending throughout from said proximal end to said distal end, said elongate member having a cavity in said distal end; and
a weight member, said weight member being inserted into said elongate member cavity, said weight member being frictionally engaged with said elongate member cavity.

9. The component of claim 8 wherein said elongate member consists of a soft, flexible material.

10. The component of claim 9 wherein said soft, flexible material is substantially composed of plastisol.

11. The component of claim 9 wherein said cavity is conical, bullet, or egg shaped.

12. The component of claim 11 wherein said weighted member is conical, bullet, or egg shaped.

13. The component of claim 12 wherein said aperture member is sized for slideable engagement with a fishing line.

14. The component of claim 13 wherein said aperture member is sized for frictional engagement with a fishing line.

15. An artificial fishing lure, comprising:
a first elongate member having a proximal end and a distal end, said first elongate member distal end being substantially broader than said proximal end, said first elongate member having an outer surface wherein said first elongate member outer surface conically tapers from said distal end to said proximal end, said first elongate member having a slender aperture extending throughout from said proximal end to said distal end, said first elongate member having a cavity in said distal end, said first elongate member being soft and flexible;
a weight member, said weight member being inserted into said elongate member cavity, said weight member being frictionally engaged with said elongate member cavity;
a hook member, said hook member having an eye, a shank, a barb, and a point;
a second elongate member, said second elongate member having a first end and a second end, said second elongate member being soft and flexible; and
a monofilament wherein said monofilament is inserted through said aperture in said first elongate member, said monofilament being further inserted through said weighted member, said monofilament being fixedly engaged with said eye of said hook member, said hook member being engaged with said second elongate member such that a portion of said shank, said barb, and said point remain inserted into said second elongate member.

16. The lure of claim 15 wherein said aperture member is sized for slideable engagement with said monofilament.

17. The lure of claim 15 wherein said aperture member is sized for frictional engagement with said monofilament.
